(19) United States
(12) Patent Application Publication
(10) Pub. No.: US 2026/0077592 A1
(43) Pub. Date: Mar. 19, 2026

(54) LIQUID DISCHARGE HEAD, LIQUID DISCHARGE APPARATUS, AND LIQUID DISCHARGE METHOD

(71) Applicant: Naoyuki TAKEZOE, Tokyo (JP)

(72) Inventor: Naoyuki TAKEZOE, Tokyo (JP)

(21) Appl. No.: 19/200,935

(22) Filed: May 7, 2025

(30) Foreign Application Priority Data
Sep. 17, 2024 (JP) 2024-160259

(51) Int. Cl. B41J 2/14; B41J 2/045; B41J 2/165; B41J 2/19; B41J 2/20

(52) U.S. Cl. CPC B41J 2/14233; B41J 2/04581; B41J 2/04588; B41J 2/04596; B41J 2/1433; B41J 2/1652; B41J 2/19; B41J 2/20; B41J 2002/14306; B41J 2002/14419

(57) ABSTRACT

A liquid discharge head includes a pressure chamber; a nozzle to discharge a liquid from the pressure chamber; a nozzle plate on the pressure chamber; and an actuator on the nozzle plate, the actuator deforming the nozzle plate to discharge the liquid in the pressure chamber from the nozzle, wherein a drive voltage is applied to the actuator to generate a controlled flow of the liquid in the pressure chamber.

### CROSS-REFERENCE TO RELATED APPLICATIONS

This patent application is based on and claims priority pursuant to 35 U.S.C. § 119(a) to Japanese Patent Application No. 2024-160259, filed on Sep. 17, 2024, in the Japan Patent Office, the entire disclosure of which is hereby incorporated by reference herein.

### BACKGROUND

### Technical Field

The present disclosure relates to a liquid discharge head, a liquid discharge apparatus, and a liquid discharge method

### Related Art

Currently, a liquid discharge head is known to discharge liquid from nozzles by vibrating the nozzle plate formed on the nozzles.

### SUMMARY

According to the present disclosure, a liquid discharge head includes a pressure chamber; a nozzle to discharge a liquid from the pressure chamber; a nozzle plate on the pressure chamber; and an actuator on the nozzle plate, the actuator deforming the nozzle plate to discharge the liquid in the pressure chamber from the nozzle, wherein a drive voltage is applied to the actuator to generate a controlled flow of the liquid in the pressure chamber.

### BRIED DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of a liquid discharge head;

FIG. 2 is a schematic cross-sectional view of the II-II line in FIG. 1;

FIG. 3 is a schematic cross-sectional view illustrating an air bubble trapped in a pressure chamber;

FIG. 4 is a schematic cross-sectional view illustrating a liquid discharge head according to a conventional unimorph-type piezoelectric method;

FIG. 5 is a schematic cross-sectional view illustrating an example of controlled liquid flow in the liquid discharge head;

FIG. 6 is a schematic cross-sectional view illustrating how an air bubble trapped inside of a pressure chamber of the liquid discharge head is moved to a position where they can be discharged by a controlled flow of liquid;

FIG. 7 is a graph of a drive voltage when liquid is discharged from the liquid discharge head;

FIG. 8 is a graph of a drive voltage during micro-driving in the liquid discharge head;

FIG. 9 is a schematic cross-sectional diagram illustrating an experimental method for evaluating a flow in a pressure chamber;

FIG. 10 is a diagram illustrating results of a first example of a simulation to evaluate a flow in a pressure chamber;

FIG. 11 is a schematic cross-sectional view illustrating a controlled liquid flow in another liquid discharge head;

FIG. 12A is a diagram illustrating results of a second example of a simulation to evaluate a flow in a pressure chamber;

FIG. 12B is a graph of an expansion and a contraction of a pressure chamber due to a vibration of a nozzle plate;

FIG. 13 is a schematic cross-sectional view illustrating another example of a liquid discharge head;

FIG. 14 is a schematic cross-sectional view illustrating yet another example of a liquid discharge head;

FIG. 15 is a schematic cross-sectional view illustrating an air bubble trapped in the pressure chamber of FIG. 14;

FIG. 16 is a schematic cross-sectional view illustrating how an air bubble trapped inside a pressure chamber of the liquid discharge head of FIG. 14 is moved to a position where it can be discharged by a controlled flow of liquid;

FIG. 17 is a schematic cross-sectional view illustrating a first example of liquid agitation in yet another example of a liquid discharge head;

FIG. 18 is a schematic cross-sectional view illustrating a second example of liquid agitation in the liquid discharge head of FIG. 17;

FIG. 19 is a block diagram illustrating a hardware configuration of a control system of a liquid discharge apparatus;

FIG. 20 is a schematic side view illustrating a first example of an overall configuration of a liquid discharge apparatus;

FIG. 21 is a schematic bottom view illustrating a head unit in a liquid discharge apparatus;

FIG. 22 is a schematic side view illustrating a second example of an overall configuration of a liquid discharge apparatus;

FIG. 23 is a schematic diagram illustrating a configuration around a liquid discharge unit in the liquid discharge apparatus of FIG. 22;

FIG. 24 is a schematic top view illustrating a first example of a liquid discharge unit;

FIG. 25 is a schematic side view illustrating a second example of a liquid discharge unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the attached drawings. In the drawings for illustrating embodiments of the present disclosure, like elements or like components in function or shape are given like reference signs as far as distinguishable, and overlapping descriptions may be omitted.

In each drawing, cartesian coordinates with X, Y, and Z axes are used for directional expressions: the X, Y, and Z axes are orthogonal to each other; the arrow on the X axis points in the +X direction or +X side, and the arrow on the Y axis points in the −X direction or −X side. The direction in which the arrow on the Y-axis points is denoted as +Y or +Y side, and the direction opposite to +Y is denoted as −Y or −Y side. The direction opposite to the +Z direction is denoted as −Z direction or −Z side. The liquid discharge head discharges liquid in the +Z direction.

However, the above terms indicating specific directions and positions are only used to make the relative directions and positions in the referenced drawings easier to understand. These terms do not limit the orientation of the embodiments, and the orientation of the liquid discharge head in use for the embodiments is arbitrary. In this specification, “arranging” is not limited to cases of direct contact, but also includes cases of indirect arrangement, for example, through other members.

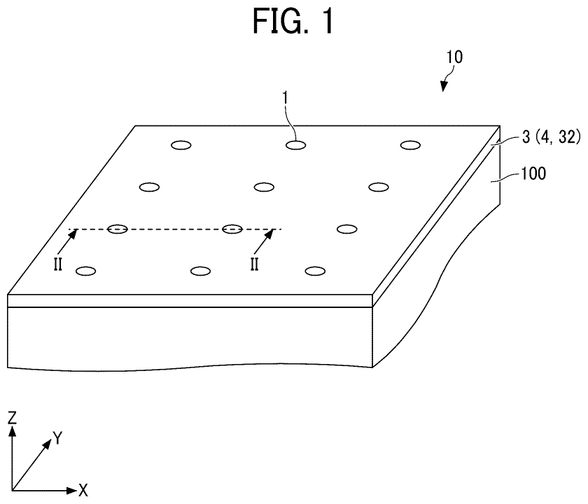

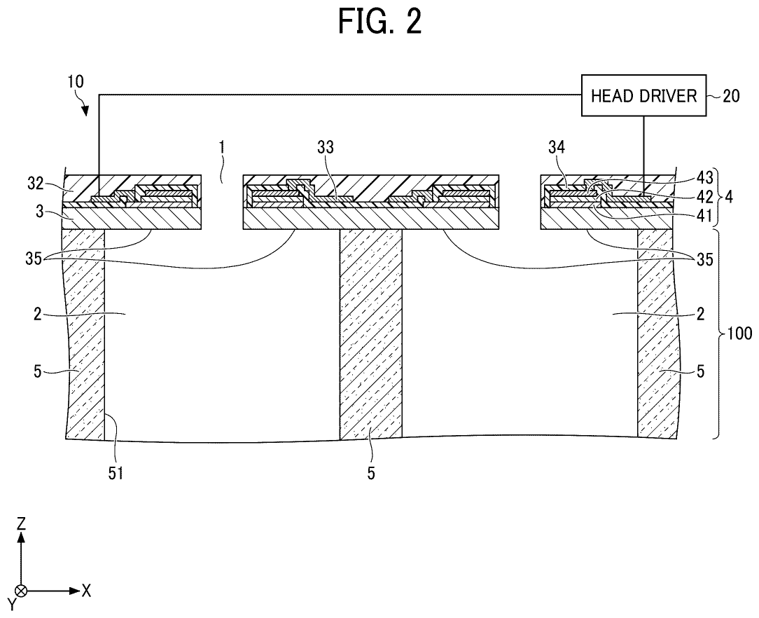

FIG. 1 is a schematic diagram of a liquid discharge head 10. FIG. 2 is a schematic cross-sectional view of the II-II line in FIG. 1.

As illustrated in FIGS. 1 and 2, a liquid discharge head 10 has a nozzle 1 to discharge liquid, a pressure chamber 2 connected to the nozzle 1, and a nozzle plate 3 through which the nozzle 1 is formed. The liquid discharge head 10 also has an actuator 4 that deforms the nozzle plate 3 to discharge liquid in the pressure chamber 2 from the nozzle 1. As illustrated in FIGS. 1 and 2, the liquid discharge head 10 has a channel substrate 100 on which the liquid flows. The nozzle plate 3 is a thin-film member disposed on the +Z side of the channel substrate 100, i.e., the side where liquid is discharged from the liquid discharge head 10, and extending in the X and Y directions.

As illustrated in FIGS. 1 and 2, the liquid discharge head 10 has a plurality of nozzles 1 and a plurality of pressure chambers 2. The plurality of nozzles 1 are formed on the nozzle plate 3 in line in each of the X and Y directions. The plurality of pressure chambers 2 are formed on the channel substrate 100. The plurality of pressure chambers 2 are connected to the plurality of nozzles 1 corresponding to the plurality of nozzles 1. A partition 5 is a wall separating the plurality of pressure chambers 2 aligned in each of the direction and the Y direction.

The nozzle plate 3 may include a diaphragm. As illustrated in FIG. 2, liquid discharge apparatus 10 may further include a protective film 32 disposed on the +Z side of the nozzle plate 3, a wiring 33 electrically connected to the actuator 4, and an interlayer insulating film 34 covering the actuator 4. The wiring 33, interlayer insulating film 34, and actuator 4 are disposed on the +Z side of the nozzle plate 3 and inside the protective film 32. The protective film 32 protects the wiring 33, the interlayer insulating film 34, and the actuator 4 by covering them.

The nozzle plate 3 has an inner surface 35 facing the pressure chamber 2. The pressure chamber 2 is a space defined by at least an inner surface 51 of the partition 5 and the inner surface 35 of the nozzle plate 3. The interior space of each of the plurality of pressure chambers 2 is filled with a liquid. A plurality of actuators 4 are arranged corresponding to the plurality of pressure chambers 2.

As illustrated in FIG. 2, the actuator 4 has a lower electrode 41, a piezoelectric film 42 disposed on the +Z side of lower electrode 41, and an upper electrode 43 disposed on the +Z side of piezoelectric film 42. As illustrated in FIG. 2, the actuator 4 is a piezoelectric element including piezoelectric film 42. The upper electrode 43 is connected to the wiring 33. The actuator 4 is applied to a drive voltage that drives the actuator 4 through the wiring 33. When the actuator 4 is driven, the nozzle plate 3 is deformed. The pressure in the pressure chamber 2 changes due to the deformation of the nozzle plate 3. The pressure change in the pressure chamber 2 causes the liquid to be discharged from the nozzle 1.

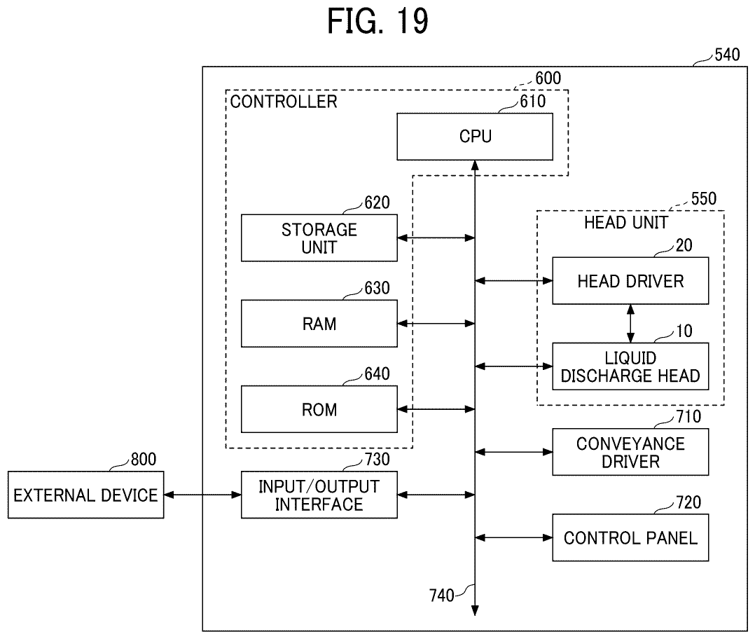

The drive voltage applied to the actuator 4 may be generated by a drive circuit integrally formed in the liquid discharge head 10 or by an externally connected device. An example of the drive circuit may be head driver 20 shown in FIG. 19, which will be discussed later. When the drive circuit is formed integral to the liquid discharge head 10, for example, the channel substrate 100 is formed by applying a MEMS (Micro Electro Mechanical Systems) process to a SOI (Silicon on Insulator) substrate. The drive circuit includes transistors, resistors, etc. formed on the flow channel substrate 100.

The partition 5 includes a silicon (Si). The nozzle plate 3 includes a silicon oxide (SiO2). The piezoelectric film 42 includes a scandium aluminum nitride (ScAlN) thin film.

The protective film 32 incudes a benzocyclobutene (BCB). The protective film 32 may be a liquid repellent film. Applying the protective film 32 as the liquid repellent film prevents an adhesion of the liquid to an outer surface of the nozzle plate 3 and prevents the liquid discharged from the nozzle 1 from being affected by the liquid that has adhered to the outer surface of the nozzle plate 3. When the solvent of the liquid is water-based, perfluorodecyltrichlorosilane or perfluorooctyltrichlorosilane may be used as a material of the liquid repellent film.

The wiring 33 is independently connected to the actuators 4 arranged in each of the plurality of pressure chambers 2. The liquid discharge head 10 can discharge the liquid from the plurality of nozzles 1 individually by driving the plurality of actuators 4 individually by applying drive voltage to the plurality of actuators 4 to which the wiring 33 is connected.

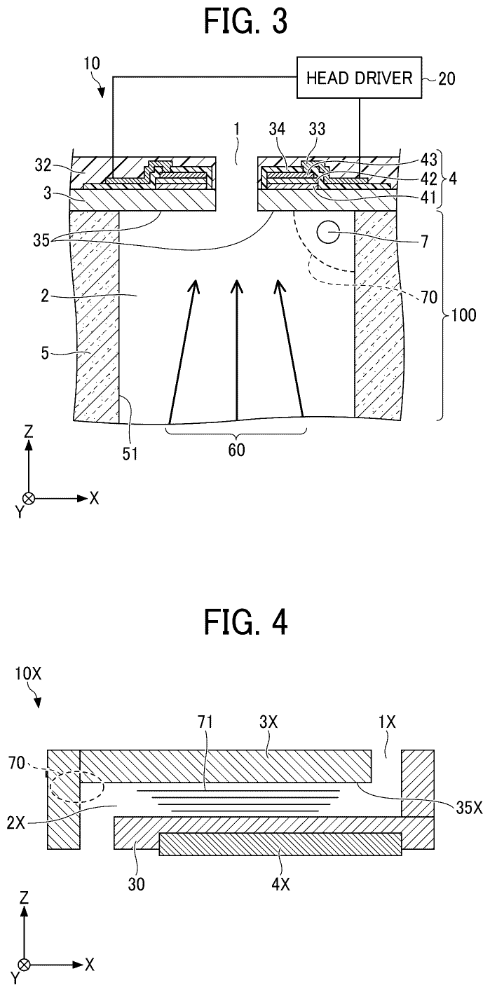

Here, an effect of an air bubble in the pressure chamber of the liquid discharge head on liquid discharge will be described referring to FIGS. 3, 4, 5, and 6. In a liquid discharge head, the air bubble may be generated in the liquid filled into the pressure chamber. The air bubble in the pressure chamber absorb the pressure applied to the liquid in the pressure chamber by the actuator. Absorption of pressure by the air bubble may cause non-discharge of the liquid from the nozzle or discharge failure, where the volume, discharge speed, discharge direction, etc. of the liquid discharged from the nozzle deviates from the specified values.

As a method to remove the air bubble in the pressure chamber, it is known that the air bubble is forcibly discharged from the pressure chamber together with the liquid in the pressure chamber by pressurizing or suction purging the liquid in the pressure chamber. Pressurizing the liquid in the pressure chamber can be performed, for example, by driving an actuator. Suction purging the liquid in the pressure chamber can be performed, for example, by suctioning the liquid in the pressure chamber through the nozzle using a suction pump disposed outside the liquid discharge head.

However, in the pressure chamber, a stagnant area where the liquid stagnates may occur in the corners of the pressure chamber. Here, FIG. 3 is a schematic cross-sectional view illustrating an air bubble trapped in the pressure chamber. A dashed line is the stagnant area 70 that occurs in the corner of the pressure chamber 2. An air bubble 7 is the air bubble present in the liquid in the stagnant area 70. A purge flow 60 illustrated by an arrow, is the flow of the liquid in the pressure chamber 2 generated by purging, which pressurizes or suctions the liquid in the pressure chamber 2. The direction of the arrow indicating the purge flow 60 is the direction of the flow of the liquid in the purge flow 60.

FIG. 4 is a schematic cross-sectional view illustrating a liquid discharge head according to a conventional unimorph-type piezoelectric method. In FIG. 4, the configuration in a liquid discharge head 10X that has the same function as the liquid discharge head 10 is illustrated by adding “X” to the sign of the configuration in the liquid discharge head 10 and corresponding to it.

In the liquid discharge head 10X, a method of using acoustic waves 71 generated in the pressure chamber 2X by micro-driving is known to discharge the air bubble or to prevent drying of the liquid. Here, the micro-driving refers to a driving method in which the liquid in the pressure chamber 2X is driven without discharging the liquid from the nozzle 1X by applying a drive voltage to the actuator 4X, which has a smaller voltage value than the drive voltage that causes the liquid to be discharged from the nozzle 1X. In the micro-driving in the liquid discharge head 10X, the liquid in the pressure chamber 2X is driven finely by the acoustic waves 71 generated by vibrating the actuator 4X, which is disposed on an opposite wall 30 facing the inner surface 35X of the nozzle plate 3X.

However, in the liquid discharge head 10X, the acoustic wave 71 does not reach the liquid in the stagnant area 70 in the corner of the pressure chamber 2X, and the liquid in the stagnant area 70 cannot be moved. Therefore, the liquid discharge head 10X cannot move the air bubble 7 in the stagnant area 70 to a position where it can be discharged by pressurization or suction and cannot be discharged. The air bubble 7 remains in the pressure chamber 2X without being discharged from the pressure chamber 2X, which may cause non-discharge or poor discharge in the liquid discharge head 10X.

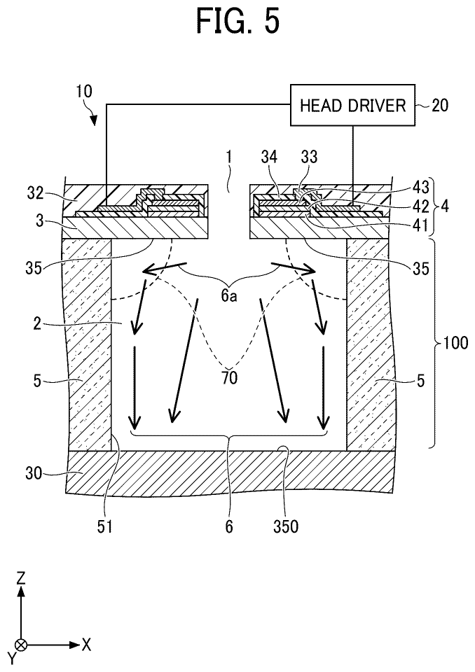

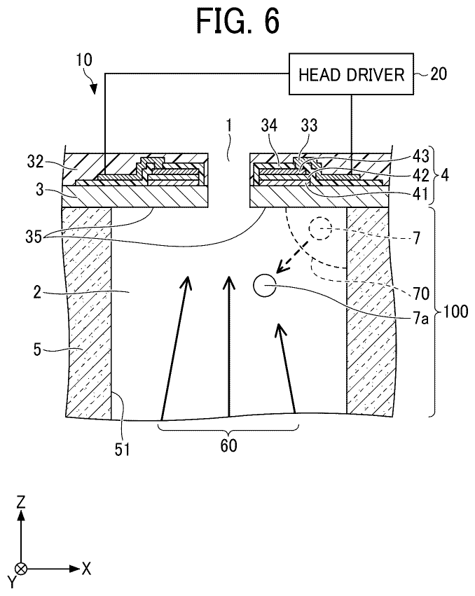

As illustrated in FIG. 5, for example, a controlled flow 6 is generated in the liquid in the pressure chamber 2 by applying the drive voltage to the actuator 4 disposed on the nozzle plate 3 in order to reduce the stagnant areas 70 and discharge the air bubble 7 in the stagnant area 70. Here, FIG. 5 is a schematic cross-sectional view illustrating a first example of controlled flow 6 of the liquid in the liquid discharge head 10. FIG. 6 is a schematic cross-sectional view illustrating how an air bubble trapped inside of the pressure chamber 2 of the liquid discharge head 10 is moved to a position where it can be discharged by a controlled flow 6 of liquid. A controlled flow 6 illustrated by the arrow in FIG. 5 is the first example of a controlled flow 6 in the liquid discharge head 10. The direction of the arrow indicating the controlled flow 6 is the direction of the flow of the liquid in the controlled flow 6.

As illustrated in FIG. 5, the liquid discharge head 10 generates a controlled flow 6. The controlled flow 6 includes a flow 6a of liquid along the inner surface 35 of the nozzle plate 3. In another aspect, the controlled flow 6 includes a flow 6a in a direction away from the nozzle 1. In yet another aspect, the controlled flow 6 includes the controlled flow 6a that occurs closer to the inner surface 35 than a facing surface 350 opposite the inner surface 35 in the pressure chamber 2. The facing surface 350 is the surface opposite the inner surface 35 in the opposite wall 30 disposed opposite the nozzle plate 3.

The controlled flow 6a along the inner surface 35 of the nozzle plate 3, the controlled flow 6a in the direction away from the nozzle 1, or the controlled flow 6a closer to the inner surface 35 than the facing surface 350 may be at least part of the controlled flow 6 generated by the application of the drive voltage to the actuator 4. The term “along the inner surface 35” refers to the direction of the controlled flow 6 having an inclination of ±20 degrees or less with respect to the inner surface 35.

As illustrated in FIG. 5, the liquid in the pressure chamber 2 flows along the inner surface 35 in a direction away from the nozzle 1 at a position closer to the inner surface 35 than the facing surface 350. The liquid in the pressure chamber 2 then hits the inner surface 51 of the partition 5 and flows along the inner surface 51 to the side opposite to the side where the nozzle 1 is located, i.e., the −Z side.

The controlled flow 6 in the direction away from the nozzle 1 along the inner surface 35 also extends on the liquid in the stagnant area 70, such as the corners of the pressure chamber 2. From another perspective, the controlled flow 6 contributes to the movement of the liquid in the stagnant area 70. The liquid discharge head 10 allows the liquid in the stagnation area 70 to flow by means of the controlled flow 6. As illustrated in FIG. 6, the controlled flow 6 allows the liquid discharge head 10 to move the air bubble 7 which exists in the liquid in the stagnant area 70, from a position where it cannot be discharged by pressurization or suction, to a position where it can be discharged by pressurization or suction. As illustrated in FIG. 6, the air bubble 7 indicated by the dashed line represents the air bubble before it is moved. The air bubble 7a indicated by a solid line represents the bubble after it has been moved. The “position at which it can be discharged by pressurization or suction” means the position at which the purge flow 60 contributes to the movement of the air bubble 7, and at which the liquid can be discharged by pressurization or suction.

Moving the air bubble 7 to a position where it can be discharged by pressurization or suction allows the liquid discharge head 10 to discharge the air bubble 7 from the pressure chamber 2 through the nozzle 1 by pressurization or suction. The maximum pressure for pressurization or suction is about 100 kPa, and to create many pass lines in the pressure chamber 2, the pressure should be 50 kPa or less.

The discharge of the air bubble 7 from the pressure chamber 2 reduces non-discharge or poor discharge due to the air bubble 7. As a result, the stability of liquid discharge by the liquid discharge head 10 can be improved. The liquid discharge head 10 is not limited to nozzle 1, but may also discharge the air bubble 7 from the inlet of pressure chamber 2, which is disposed on the opposite side of nozzle 1 across pressure chamber 2.

As illustrated in FIG. 6, the purge flow 60 allows the air bubble 7 to move in the vicinity of the nozzle 1 or the inlet of the pressure chamber 2. The movement of the air bubble 7 allows only the liquid in the pressure chamber 2 in the vicinity of the nozzle 1 or in the vicinity of the inlet of the pressure chamber 2 to be discharged by pressurization or suction, and the air bubble 7 can be discharged from the pressure chamber 2. As a result, the amount of the liquid to be discharged by pressurization or suction can be reduced and the consumption of liquid can be reduced.

The effect of the liquid discharge apparatus 10 as illustrated in FIG. 6 is not limited to those obtained by discharging the air bubble 7. For example, generating the purge flow 60 allows the liquid in the pressure chamber 2 to flow. The flow of the liquid in the pressure chamber 2 reduces the thickening of the liquid in the pressure chamber 2 because the liquid existed in the vicinity of the nozzle 1 is successively replaced. As a result, non-discharge or discharge failure due to thickening of the liquid in the pressure chamber 2 can be reduced.

As illustrated in FIG. 6, to reduce liquid stagnation in the pressure chamber 2 and suitably discharge the air bubble 7, the controlled flow 6 is the flow along the inner surface 35 of the nozzle plate 3. To further reduce liquid stagnation and suitably discharge the air bubble 7, the controlled flow 6 is the flow along the inner surface 35 of the nozzle plate 3 in a direction away from the nozzle 1. And, the controlled flow 6 is the flow in a direction away from the nozzle 1 along the inner surface 35 of the nozzle plate 3 at a position in the vicinity of the inner surface 35 of the nozzle plate 3 than the facing surface 350.

As illustrated in FIG. 6, the liquid discharge head 10 can discharge part of the liquid in the pressure chamber 2 from the pressure chamber 2 by pressurization or suction. Generating the controlled flow 6 allows the liquid discharge head 10 to move the air bubble 7 which exists in the position where the air bubble 7 cannot be discharged by pressurization or suction in the pressure chamber 2 to position where the air bubble 7 can be discharged by pressurization or suction. The movement of the air bubble 7 allows the discharge of the air bubble 7 previously existed in the position where pressurization or suction could not discharge them from the pressure chamber 2.

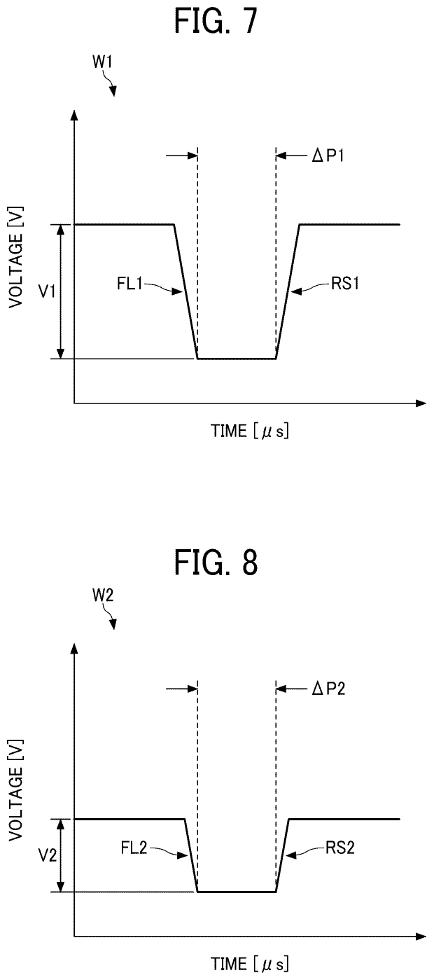

Next, the control method of flow 6 in the liquid discharge head 10 will be described with reference to FIGS. 7 and 8. FIG. 7 is a graph of a drive voltage when liquid is discharged from the liquid discharge head 10. FIG. 8 is a graph of a drive voltage during micro-driving in a liquid discharge head 10.

The liquid discharge head 10 generates the controlled flow 6 in the liquid in the pressure chamber 2 by applying the drive voltage to the actuator 4. The higher the flow velocity of the fluid in pressure chamber 2, the greater the movement of the liquid and the air bubble in pressure chamber 2, making it easier for the air bubble to be discharged. On the other hand, if the applied drive voltage is large, outside air may be drawn into the pressure chamber 2 through the nozzle 1. The air drawn in may become an air bubble, and increase a volume of air bubbles in the pressure chamber 2. Therefore, to discharge the air bubble and reducing the air bubbles, the drive voltage applied to the actuator 4 may be optimized.

As illustrated in FIGS. 7 and 8, the controlled flow 6 is controlled by at least one of a waveform, voltage value and frequency of the drive voltage applied to the actuator 4. A drive voltage W1 during the liquid discharge as illustrated in FIG. 7 is an example.

As illustrated in FIG. 7, the drive voltage W1 includes a pulse waveform. The waveform of the drive voltage W1 is determined by the parameters of pulse width ΔP1, angle of rising waveform RS1, and angle of falling waveform FL1 in the pulse waveform. The longer the pulse width ΔP1 is, up to a predetermined pulse width, the greater the displacement of the nozzle plate 3 in response to the application of the drive voltage W1. After the displacement reaches its peak at the predetermined pulse width, the longer the pulse width ΔP1 is, the smaller the displacement of the nozzle plate 3.

The steeper the angle of the rising waveform RS1, the greater the displacement of the nozzle plate 3 in response to the application of the drive voltage W1. However, depending on the structure of the liquid discharge head 10, the steeper the angle of the rising waveform RS1, the smaller the displacement of the nozzle plate 3 in response to the application of the drive voltage W1. Also, the steeper the angle of the rising waveform RS1, the greater the displacement of the nozzle plate 3 up to a predetermined rising angle. When the rising waveform RS1 exceeds the predetermined rising angle, the steeper the angle, the smaller the displacement of the nozzle plate 3. In the angle of the falling waveform FL1, the relationship between the angle and the displacement of the nozzle plate 3 is the same as the relationship between the angle and the displacement of the nozzle plate 3 in the rising waveform RS1.

A voltage value V1 of the drive voltage W1 has a simple proportional relationship with the displacement of nozzle plate 3 in response to the application of the drive voltage W1. The higher the voltage value V1, the greater the displacement of the nozzle plate 3 in response to the application of drive voltage W1. However, the voltage value V1 needs to be less than the breakdown voltage value of the piezoelectric film 42 in the actuator 4.

Depending on the timing of controlling the controlled flow 6, the liquid may not be discharged from the nozzle 1. In this case, the drive voltage W2 for micro-driving as illustrated in FIG. 8 is applied to the liquid discharge head 10. The drive voltage W2 includes a pulse waveform similar to the drive voltage W1. The waveform of the drive voltage W2 is determined by the parameters of pulse width ΔP2, angle of rising waveform RS2, and angle of falling waveform FL2 in the pulse waveform. The drive voltage W2 has a smaller voltage value V2 than the voltage value V1 of the drive voltage W1. The smaller voltage value V2 results in a smaller displacement of the nozzle plate 3 in response to the application of the drive voltage W2. The smaller pressure applied to the liquid in the pressure chamber 2 prevents the liquid from being discharged from the pressure chamber 2.

In another aspect, the liquid discharge head 10 can generate the controlled flow 6 by applying to the actuator 4 the drive voltage W2 which does not discharge the liquid from the nozzle 1 and has the smaller voltage value V2 than the voltage value V1 of the drive voltage W1 which discharges the liquid from the nozzle 1.

For example, the voltage value V2 at the drive voltage W2 is 70% or 50% of the voltage value V1 at the drive voltage W1. Regarding power consumption reduction, the voltage value V2 may be between 25% and 30% of the voltage value V1. When drive voltage W2 is applied to the liquid discharge head 10, the liquid is not discharged from nozzle 1, but the liquid in pressure chamber 2 vibrates.

Next, the frequency at which the drive voltage W1 is applied will be explained. In a first method, the drive voltage W1 is applied to use the superposition of waves in the controlled flow 6 generated by the displacement of the nozzle plate 3. The higher the frequency of the drive voltage W1 and the more the waves which are repeatedly generated in response to the application of the drive voltage W1 overlap each other, the higher the flow rate of the controlled flow 6. Therefore, the maximum frequency at which the unit waveforms do not overlap each other is determined by considering the waveform length of the unit waveforms in the drive voltage W1. In a second method, the frequency of the drive voltage W1 to be applied to the resonance frequency of the pressure chamber 2 is set such that the pressure chamber 2 is resonated to generate the controlled flow 6. For example, if the resonance frequency of the pressure chamber 2 filled with the liquid is 100 kHz, the frequency of the drive voltage W1 to be applied is set to 100 kHz or the frequency at which the resonance vibration amplitude is maximum. This frequency determination will cause the entire liquid in the pressure chamber 2 to resonate and generate the controlled flow 6 with a larger flow rate.

In both methods, the frequency at which the drive voltage W1 is applied such that the waveform with the maximum displacement of the nozzle plate 3 is repeatedly applied as the unit waveform. For example, if the frequency is 2 kHz, the unit waveform of the drive voltage W1 is applied to the actuator 4 once every 500 μs. At least one of the two methods is used depending on the shape and size of the pressure chamber 2.

As illustrated in FIGS. 7 and 8, the controlled flow 6 is controlled by at least one of the waveform, voltage value and frequency of the drive voltage W1 or drive voltage W2 applied to the actuator 4. Controlling the controlled flow 6 allows the drive voltage W1 or drive voltage W2 to be optimized according to the shape and size of the pressure chamber 2. Optimizing the drive voltage W1 or drive voltage W2 allows the bubbles to be suitably discharged and reduced.

As illustrated in FIGS. 7 and 8, the nozzle plate 3 may vibrate when the drive voltage is applied to the actuator 4. The vibration of the nozzle plate 3 allows to generate the controlled flow 6 with a specified, designated or predetermined flow rate, velocity or flow direction.

As illustrated in FIGS. 7 and 8, the actuator 4 may be a piezoelectric element. The actuator 4 may be a piezoelectric element. The actuator 4 formed of the piezoelectric element allows the controlled flow 6 to be generated while simplifying the configuration of the liquid discharge head 10. However, the actuator 4 is not limited to a piezoelectric element, but may be an electrostatic or a thermal actuator.

As illustrated in FIGS. 7 and 8, the liquid discharge head 10 can generate the controlled flow 6 by applying to the actuator 4 the drive voltage W2 which does not discharge the liquid from the nozzle 1 and has the smaller voltage value V2 than the voltage value V1 of the drive voltage W1 which discharges the liquid from the nozzle 1. For example, when the liquid discharge head 10 discharges the liquid to form an image on a recording medium such as paper, if the liquid in the pressure chamber 2 is discharged to discharge air bubble during the period when an image is being formed, the liquid which does not contribute to image formation may adhere to the recording medium, and may stain the recording medium. The liquid discharge head 10 generates the controlled flow 6 without discharging the liquid by the micro-driving. Generating the controlled flow 6 allows the liquid discharge head 10 to move and discharge the air bubble during periods when the liquid discharge head 10 should not discharge liquid.

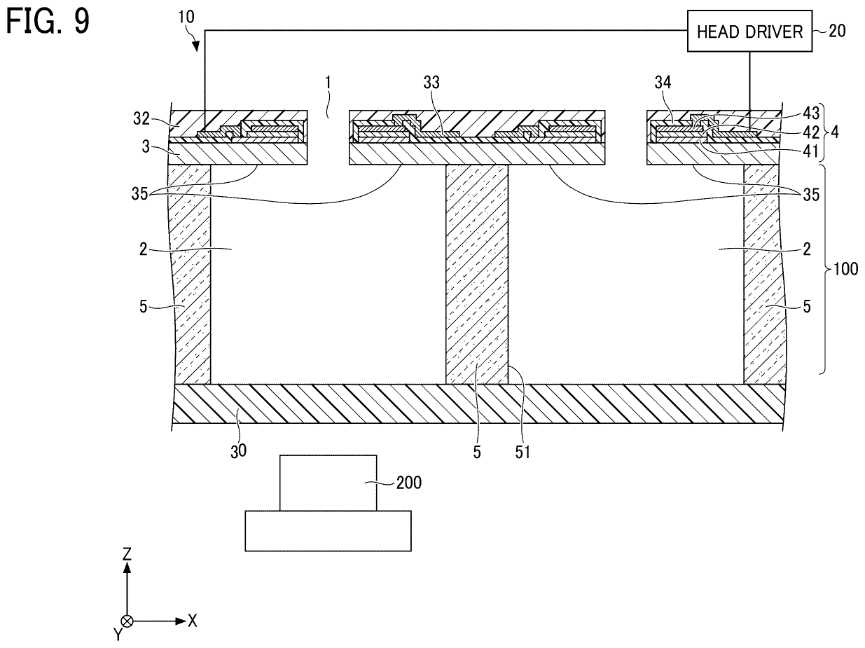

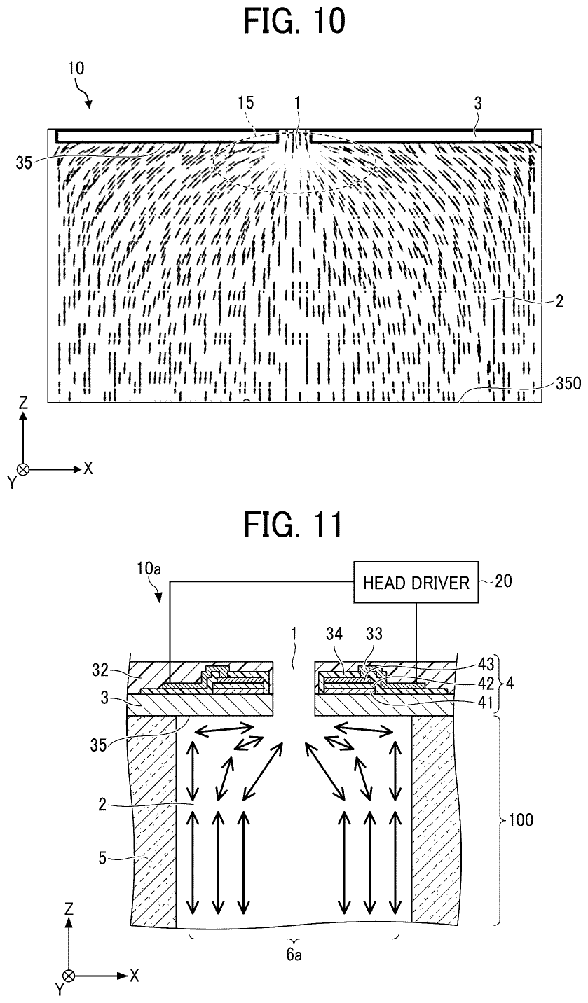

The controlled flow 6 may be evaluated by experiment or simulation. An evaluation method of the controlled flow 6 will be described with reference to FIGS. 9 and 10. FIG. 9 is a schematic cross-sectional diagram illustrating an experimental method for evaluating a flow in a pressure chamber. FIG. 10 is a diagram illustrating results of a first example of a simulation to evaluate a flow in a pressure chamber.

As illustrated in FIG. 9, the opposite wall 30 is a member that constitutes the pressure chamber 2 and is disposed opposite the nozzle plate 3. The opposite wall 30 includes a glass material or resin material which is translucent to visible light. The optical microscope 200 is a microscope which can take still or moving images visualizing an inside of the pressure chamber 2 through the opposite wall 30.

In the controlled flow 6 evaluation experiment, the pressure chamber 2 is filled with the liquid including particles of a size which can be observed by the optical microscope 200. Capturing still or moving images of the particles in the pressure chamber 2 with the optical microscope 200 allows to visualize the behavior of the particles in the pressure chamber 2. Based on the behavior of the visualized particles, the flow velocity or flow direction of the controlled flow 6 can be evaluated. If the opposite wall 30 is formed of silicon or other material which is not translucent to visible light, an infrared microscope may be used in place of the optical microscope 200.

In the example as illustrated in FIG. 9, the configuration is described to capture still or moving images of the particles in the pressure chamber 2 through the opposite wall 30. However, the configuration is not limited to this, and a still or moving image of the particles in the pressure chamber 2 may be taken by the optical microscope 200 or the infrared microscope through a wall member on the +Y or −Y side which constitutes the pressure chamber 2 in a direction orthogonal to the direction in which the liquid is discharged, for example.

The liquid including fluorescently labeled microparticles may be filled into the pressure chamber 2, and still or moving images of the fluorescently labeled microparticles in the pressure chamber 2 may be captured by the optical microscope 200 or the infrared microscope. Based on the behavior of the visualized fluorescently labeled microparticles, the flow velocity or flow direction of the liquid flow 6 can be evaluated. If the air bubble is generated in the pressure chamber 2, still or moving image of the air bubble in the pressure chamber 2 may be captured by the optical microscope 200 or the infrared microscope. Based on the behavior of the visualized air bubble, the flow velocity or flow direction of the controlled flow 6 can be evaluated.

On the other hand, in the simulation results for the first example as illustrated in FIG. 10, the flow of liquid in the pressure chamber 2 is illustrated as a velocity vector when the waveform as illustrated in FIG. 7 is applied to the actuator 4 at 200 kHz. The length of the multiple lines illustrated in the pressure chamber 2 represents the velocity of the liquid, and the direction of the multiple lines represents the direction of the liquid flow. In the first example as illustrated in FIG. 10, the flow of liquid in the direction from nozzle 1 to the wall surface direction of pressure chamber 2, for example, along the XZ plane, is visualized. In the area 15 around the nozzle 1 at a position closer to the inner surface 35 than the facing surface 350, the flow is visualized in the direction away from the nozzle 1 along the inner surface 35 of the nozzle plate 3. This flow moves the liquid and the air bubble in the pressure chamber 2 and allows to discharge the air bubble from the nozzle 1 or from the inlet of the pressure chamber 2 disposed on the opposite side of the nozzle 1.

As described above, the controlled flow 6 may be evaluated by experiment or simulation. For example, it can be evaluated in which region in the pressure chamber 2 of the liquid discharge head 10, in which direction and at what velocity the liquid flows.

Next, a variation of the liquid discharge head will be described with reference to FIG. 11. In the following description, descriptions of elements, which have already been described, identical or similar to those in embodiments as described above are omitted.

FIG. 11 is a schematic cross-sectional view illustrating a controlled liquid flow in another liquid discharge head 10a. Liquid discharge head 10a differs from the liquid discharge head 10 in that liquid discharge head 10a generates a flow 6a that switches between the flow in the direction away from the nozzle 1 and the flow in the direction closer to the nozzle 1.

As illustrated in FIG. 11, the controlled flow 6a periodically switches between the flow of the liquid in the direction away from the nozzle 1 and the flow of the liquid in the direction closer to the nozzle 1. In another aspect, in the liquid discharge head 10a, the liquid in the pressure chamber 2 is vibrating at a predetermined frequency. The frequency at which the liquid in the pressure chamber 2 vibrates corresponds to the frequency of the drive voltage applied to the actuator 4. For example, the frequency at which the liquid in the pressure chamber 2 vibrates and the frequency of the drive voltage applied to the actuator 4 are almost the same frequency.

For example, a situation may occur in which the air bubble in the pressure chamber 2 adheres to the wall surface of the pressure chamber 2 or the inner surface 35 of the nozzle plate 3 and become stuck. To address this issue, the liquid discharge head 10a generates the controlled flow 6a that switches between the flow away from the nozzle 1 and the flow closer to the nozzle 1. The controlled flow 6a allows the force to detach the air bubble attached to the wall surface of the pressure chamber 2 or the inner surface 35 of the nozzle plate 3 becomes stronger than when the flow in only one direction. As a result, the detached air bubble is easily discharged from the pressure chamber 2.

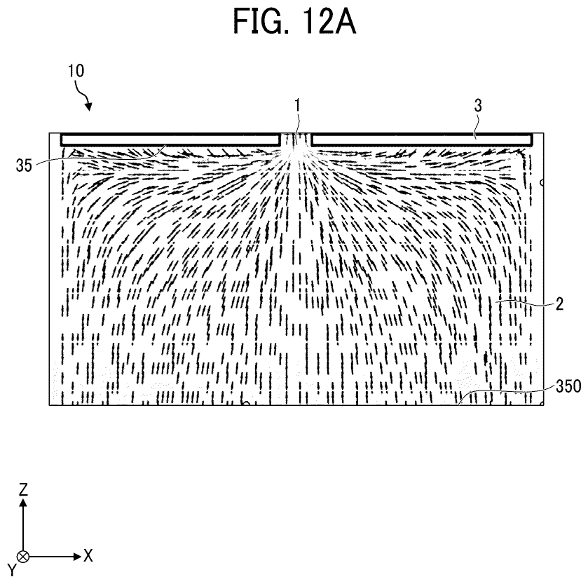

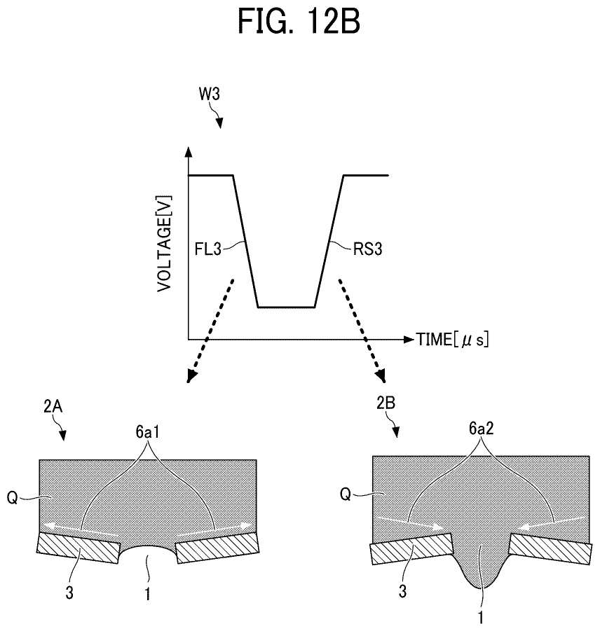

FIG. 12A is a diagram illustrating results of a second example of a simulation to evaluate a flow in a pressure chamber. The calculation conditions for the simulation results as illustrated in FIG. 12A are the same as those for the simulation results as illustrated in FIG. 10. The simulation results as illustrated in FIG. 12A is a cutaway view of the flow state of the liquid in the pressure chamber 2 at a different time to the simulation results as illustrated in FIG. 10. The interpretation of FIG. 12A is the same as FIG. 10.

In the example as illustrated in FIG. 12A, the flow in the direction from the inside of the pressure chamber 2 to nozzle 1 is visualized. In other words, in the simulation as illustrated in FIG. 10, the liquid flows from the nozzle 1 into the pressure chamber 2, while in the simulation as illustrated in FIG. 12A, the liquid flows from the inside of the pressure chamber 2 to the nozzle 1. From another perspective, In the simulation as illustrated in FIG. 12A, the liquid is the liquid in the pressure chamber 2 is vibrating.

The flow from the nozzle 1 toward the pressure chamber 2 corresponds to the flow in the direction away from the nozzle 1. The flow from the inside of the pressure chamber 2 to the nozzle 1 corresponds to the flow in the direction closer to the nozzle 1. Thus, the liquid discharge head 10 can generate the flow that switches between the flow in the direction away from the nozzle 1 and the flow in the direction closer to the nozzle 1. In another aspect, the liquid discharge head 10 can vibrate the liquid in the pressure chamber 2.

Vibrating the liquid allows to detach the air bubble attached to the wall surface of the pressure chamber 2 or the inner surface 35 of the nozzle plate 3 easily. The controlled flow 6a allows the force becomes stronger than when the flow in only one direction. As a result, the detached air bubble is discharged from the inside of the pressure chamber 2 easily. Also, vibrating the liquid allows air bubble to be discharged from both the nozzle 1 and/or the inlet of the pressure chamber 2 easily.

The direction of the flow in the pressure chamber 2 switches regardless of the frequency of the drive voltage applied to the liquid discharge head 10. A phenomenon of the flow direction switching in the pressure chamber 2 is caused by the repeated expansion and contraction of the pressure chamber 2 due to the vibration of the nozzle plate 3. Here, the phenomenon of the flow direction switching in the pressure chamber 2 will be described referring to FIG. 12B. FIG. 12B is a graph of an expansion and a contraction of a pressure chamber due to a vibration of a nozzle plate.

As illustrated in FIG. 12B, a drive voltage W3 is the drive voltage applied to the liquid discharge head 10. A first pressure chamber state 2A and a second pressure chamber state 2B are cross-sectional views in the vicinity of the nozzle 1 in the pressure chamber 2, representing the state of the pressure chamber 2 in the liquid discharge head 10. The first pressure chamber state 2A represents the state in which the nozzle plate 3 vibrates and the pressure chamber 2 expands when a falling waveform FL3 in a drive voltage W3 is applied. The second pressure chamber state 2B represents the state in which the nozzle plate 3 vibrates and the pressure chamber 2 contracts when a rising waveform RS3 in a drive voltage W3 is applied.

A flow 6a1 is the flow of liquid Q in the direction away from the nozzle 1, which occurs in the first pressure chamber state 2A. A flow 6a2 is the flow of the liquid Q in the direction closer to the nozzle 1, which occurs in the second pressure chamber state 2B. For example, when the drive voltage W3 is applied to the liquid discharge head 10 at a predetermined frequency, the nozzle plate 3 vibrates and the state of pressure chamber 2 periodically switches between the first pressure chamber state 2A and the second pressure chamber state 2B at a period corresponding to the frequency.

As illustrated in FIG. 12b, in the liquid discharge head 10, the pressure chamber 2 periodically repeats expansion and contraction due to the vibration of the nozzle plate 3. Repeating expansion and contraction of the pressure chamber 2 allows the flow of liquid Q in the pressure chamber 2 to switch periodically between a flow 6a1 in the direction away from the nozzle 1 and a flow 6a2 in the direction closer to the nozzle 1. Switching between the flow of liquid in the direction away from the nozzle 1 and the flow of liquid in the direction closer to the nozzle 1 does not need to be periodic and may be aperiodic.

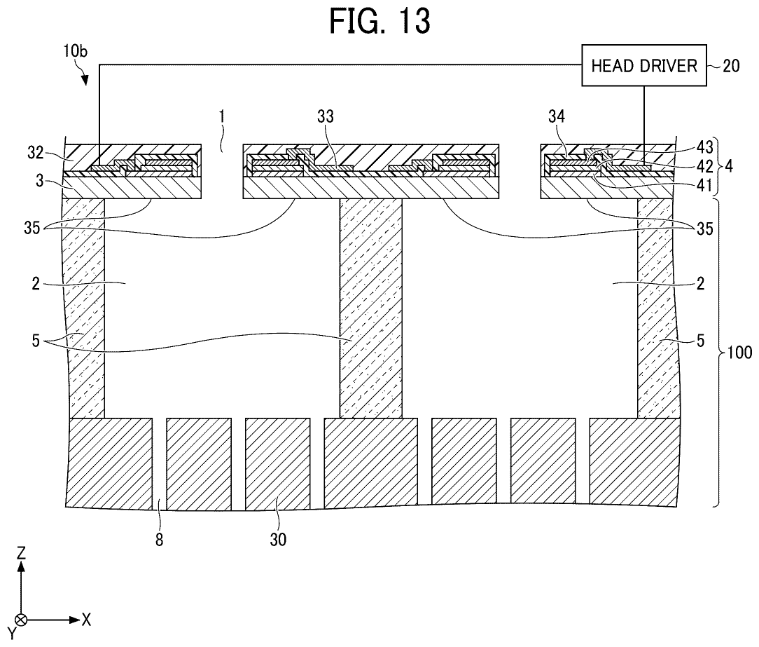

FIG. 13 is a schematic cross-sectional view illustrating another example of a liquid discharge head. FIG. 13 illustrates the cross-section of a liquid discharge head 10b corresponding to line II-II in FIG. 1.

The liquid discharge head 10b differs from the liquid discharge head 10 in that a fluid resistance 8 is formed on the opposite wall 30.

Because the pressure chambers 2 of the liquid discharge head 10b are closely arranged, there may be a situation in which the pressure generated by the actuator 4 during the liquid discharge spreads to the adjacent pressure chamber 2 and affect the liquid discharge characteristics of the nozzle 1 corresponding to the adjacent pressure chamber 2. That is, the fluid resistance 8 has the function of reducing the effect on the discharge characteristics of the nozzle 1 corresponding to the adjacent pressure chamber 2. In a common unimorph-type piezoelectric liquid discharge head, for example, the liquid discharge head which discharges the liquid by vibrating the surface opposite the nozzle connecting wall having a connecting port which connects to the nozzle of a pressure chamber, an actuator is arranged on the opposite wall of the nozzle plate. Therefore, it may be difficult to dispose the fluid resistance 8 or other parts to the opposite wall. To address these potential issues, as illustrated in FIG. 13, arranging the actuator 4 on the nozzle plate 3 allows to dispose the fluid resistance 8 or other parts on the opposite wall 30 easily.

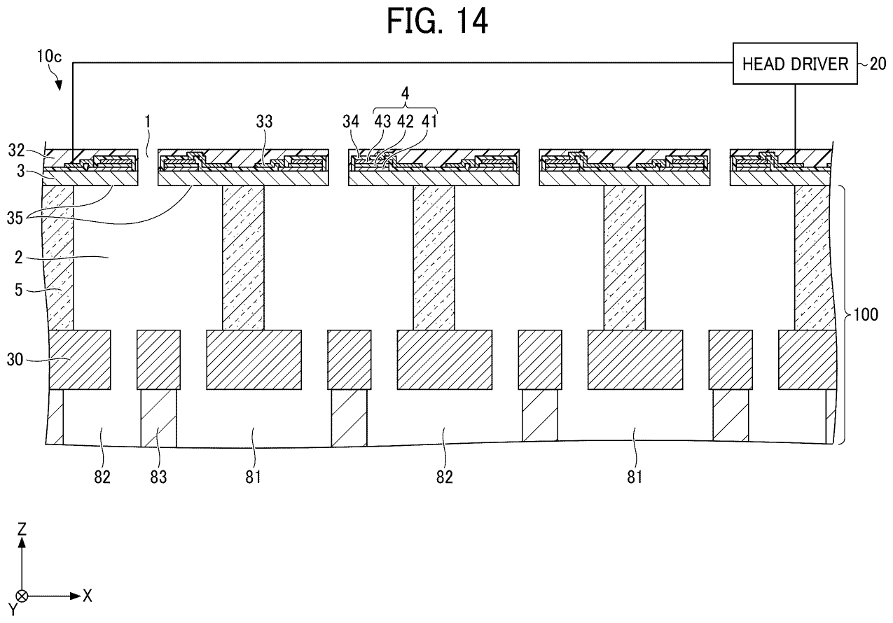

FIG. 14 is a schematic cross-sectional view illustrating yet another liquid discharge head. FIG. 14 illustrates a cross-section of a liquid discharge head 10c corresponding to the II-II line in FIG. 1. Liquid discharge head 10c differs from the liquid discharge head 10 in that the number of the nozzles 1 and the number of the pressure chambers 2 corresponding to nozzles 1 in liquid discharge head 10c are doubled.

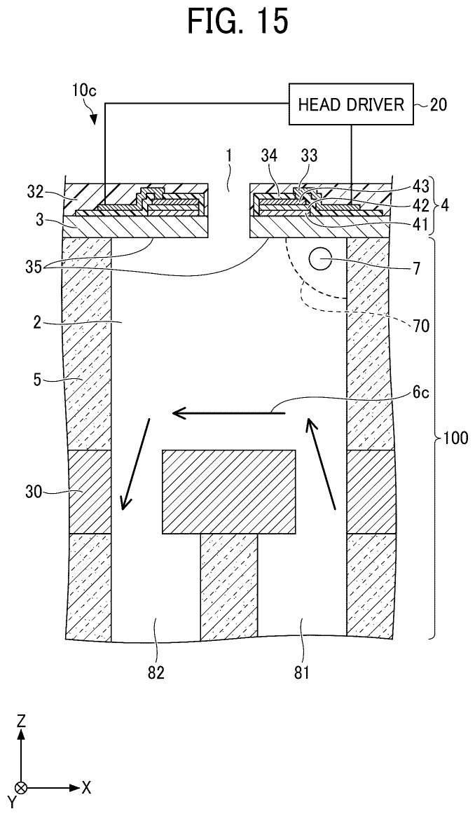

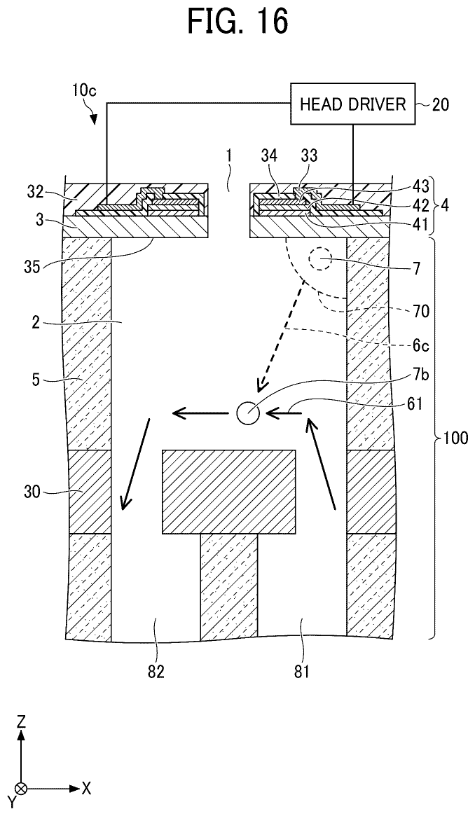

FIG. 15 is a schematic cross-sectional view illustrating an air bubble trapped in the pressure chamber of the liquid discharge head 10c of FIG. 14. FIG. 16 is a schematic cross-sectional view illustrating how an air bubble trapped inside of the pressure chamber of the liquid discharge head 10c of FIG. 14 is moved to a position where it can be discharged by a controlled flow of liquid.

The liquid discharge head 10c has a plurality of pressure chambers 2, a plurality of supply channels 81 through which the liquid is supplied to the plurality of pressure chambers 2, and a plurality of discharge channels 82 through which the liquid is discharged from the plurality of pressure chambers 2. The liquid discharge head 10c differs from the liquid discharge head 10 in that the liquid discharge head 10c allows a portion of the liquid in the pressure chambers 2 to circulate. The liquid discharge head 10c is a liquid discharge head with a liquid circulation system. the liquid discharge head with the liquid circulation system may be referred to as a flow-through head.

As illustrated in FIG. 14, a plurality of supply channels 81 and a plurality of discharge channels 82 are formed on the opposite wall 30 facing the nozzle plate 3 and are paths through which the liquid can be circulated. The supply channels 81 and the discharge channels 82 are arranged alternately. The supply channels 81 and the discharge channels 82 are separated by a channel separation wall 83. The liquid supplied to the pressure chamber 2 through the supply channel 81 is discharged from the pressure chamber 2 through the discharge channel 82. The supply and the discharge of a portion of the liquid is repeated in the pressure chamber 2, thereby circulating a portion of the liquid in the pressure chamber 2.

Circulating the liquid in the pressure chamber 2 allows to discharge the air bubble in the pressure chamber 2 and reduce drying of the liquid in the pressure chamber 2 without discharging liquid from the nozzle 1. Since the liquid discharge head 10c does not discharge the liquid to discharge the air bubble, the air bubble discharge process is not limited to the period before and after an image forming.

As illustrated in FIG. 15, even in the liquid discharge head 10c, there may be a situation in which the stagnant area 70 where liquid remains in the pressure chamber 2. The air bubble 7 in the stagnant area 70 do not move by the liquid circulation and are not discharged from within the pressure chamber 2.

For example, in order to reduce the stagnant area, it is known that the configuration of the liquid discharge head can be made by extending the length of the separation wall between the supply and discharge channels in the XY direction, for example, the direction in which the nozzle plate extends. The configuration which the separation wall between the supply and discharge channels is expanded enables to circulate the liquid exists in the vicinity of the nozzle plate and reduces the stagnant area. However, such the liquid discharge head is highly difficult to manufacture, which may worsen the yield rate of the liquid discharge head and increase the cost of the liquid discharge head.

As illustrated in FIGS. 14 and 15, in order to address the issue of liquid remaining in the stagnant area 70 and to reduce the stagnant area and discharge the air bubble in the stagnant area, the liquid discharge head 10c generates a flow 6c to move the air bubble 7 which exists in the pressure chamber 2 from the position where it cannot be discharged by the circulation of the liquid to a position where it can be discharged by the circulation of the liquid.

The example illustrated in FIG. 16 represents a case in which the liquid discharge head 10c always performs the air bubble discharge process during the period in which the liquid discharge head 10c forms the image. If the air bubble is discharged during the period when an image is being formed, the liquid which does not contribute to image formation may adhere to the recording medium, and may stain the recording medium. Therefore, the air bubble discharge process is performed by micro-driving without discharging the liquid. The voltage value of the drive voltage for micro-driving is set to 75% of the voltage value of the drive voltage for discharging the liquid. In order to reduce power consumption, the voltage value of the drive voltage applied to the actuator 4 corresponding to the nozzle 1 that performs the air bubble discharge process may be set to 50%, or 25% or less, of the voltage value of the drive voltage that discharges the liquid.

In the example as illustrated in FIG. 16, the liquid discharge head 10c moves the air bubble to the position where the circulating flow 61 occurs without discharging the liquid from the nozzle 1. The air bubble 7, indicated by the dashed line, represents the air bubble before it is moved. The air bubble 7b, shown by the solid line, represents the air bubble after it has been moved. The bubble 7b that have moved to the position where the circulating flow 61 is generated are discharged by the circulating flow 61 through the discharge channels 82 to the outside of the pressure chamber 2.

For example, if the air bubble discharge process is performed during the period when the liquid discharge head 10c is performing an image forming, the nozzles other than those subject to the air bubble discharge process are discharging for image forming. Therefore, the nozzles subject to the air bubble discharge process are identified. The process for identifying the nozzles subject to the air bubble discharge process may include, for example, the following.

First, a liquid discharge apparatus including the liquid discharge head 10c includes a detector that detects pixel omissions in the image formed on the recording medium. The liquid discharge apparatus detects pixel omissions due to the air bubble entrapment and the like by the detector, and identifies the nozzles which cause pixel omissions. The detector transmits information on the identified nozzles to the controller of the liquid discharge apparatus. The controller applies the drive voltage to the identified nozzles that is less than the voltage value of the drive voltage that causes the liquid discharge, and performs the air bubble discharge process by micro-driving. The pixels which were scheduled to be formed by the nozzles causing pixel loss are assigned to other nozzles through image processing. After a predetermined period of time has elapsed and the air bubble have been discharged, the nozzles after the bubble discharging process become available for image formation, and their use for image formation is resumed. The time required for the air bubble discharge process depends on the differential pressure of the liquid circulation in the pressure chamber 2 and the drive voltage applied to the actuator 4.

With regard to the liquid circulation effect, it is possible to design the pressure chamber such that the higher the differential pressure between the supply channels 81 and the discharge channels 82, the greater the circulation effect, or vice versa. It is also conceivable that the circulation effect will be high until a certain differential pressure is reached, and then the circulation effect will decrease after a certain value is exceeded. In any case, the differential pressure is 50 kPa. It may be less than 30 kPa to suppress variation in the liquid discharge rate due to the liquid circulation, and between 10 kPa and 20 kPa to suppress it more strictly.

In the example as described above, the voltage for micro-driving is applied only to the nozzles that cause pixel loss. However, to reduce the load on the controller, the drive voltage for micro-driving is applied to the nozzles to which no pixels are assigned.

In contrast to the above, when performing the air bubble discharge process before or after the image forming, that is, when the liquid may be discharged from the nozzle, the voltage value of the drive voltage may be set to the same voltage value that causes the liquid to be discharged, or the voltage value of the drive voltage for micro-driving as for the air bubble discharge process during the image forming.

The air bubble discharge process may be performed only on the nozzles, where bubbles are trapped in the pressure chamber 2, as identified by the detector. The drive voltage may be applied to all the pressure chambers 2 and the air bubble discharge process may be performed for all the pressure chambers 2, without specifically identifying the pressure chambers 2 where the air bubbles are trapped.

For example, in a liquid discharge head with a liquid circulation system, if a height of a pressure chamber in the Z direction in the liquid discharge head is lowered in order to discharge an air bubble by the circulation, a manufacturing difficulty of the liquid discharge head may increase and a yield of the liquid discharge head may deteriorate. Thus, a cost of the liquid discharge head may increase as a yield rate worsens.

As illustrated in FIGS. 14, 15, and 16, even if a height of the pressure chamber of the liquid discharge head 10c of the liquid circulation method is high, the controlled flow 6c allows the air bubble 7 to move in the circulation path of the liquid and discharge by the circulation of the liquid. The controlled flow 6c allows a design of the height of the pressure chamber 2 of the liquid discharge head 10c to be higher. For example, the height of the pressure chamber can be increased to about 1000 μm. As a result, the manufacturing difficulty of the liquid discharge head 10c is reduced, a yield of the liquid discharge head 10c is increased, and the cost of the liquid discharge head 10c is lowered.

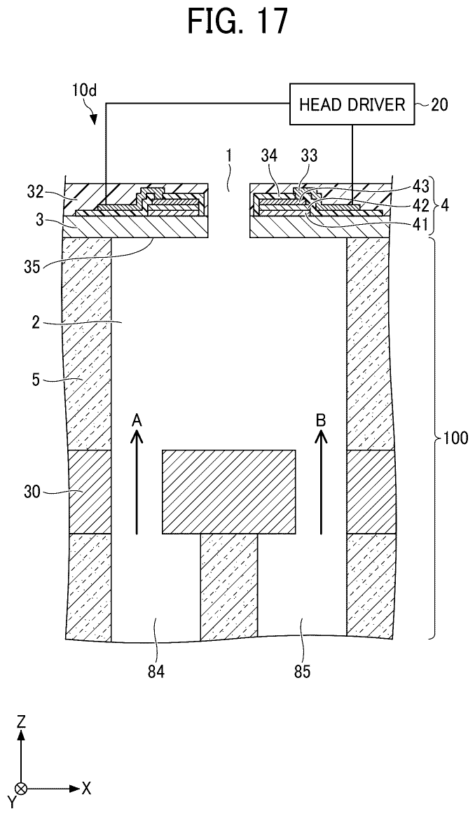

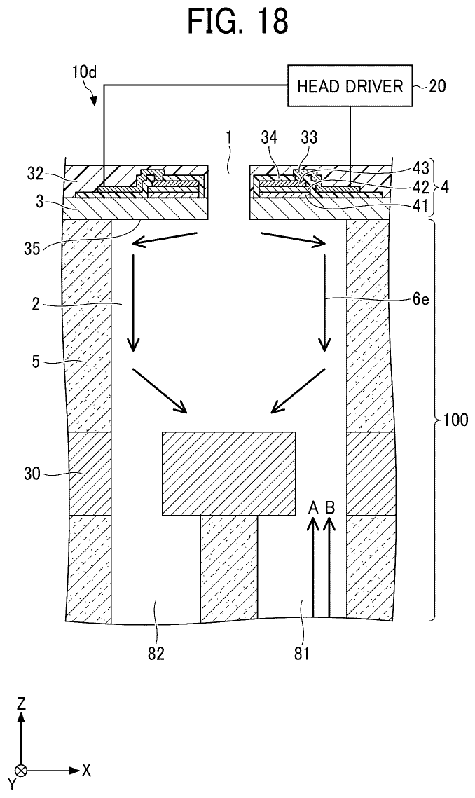

A liquid discharge head 10d will now be described with reference to FIGS. 17 and 18. FIG. 17 is a schematic cross-sectional view illustrating a first example of liquid agitation in a liquid discharge head 10d. FIG. 18 is a schematic cross-sectional view illustrating a second example of liquid agitation in the liquid discharge head 10d. As illustrated in FIGS. 17 and 18, arrows representing the liquid flow illustrates a portion of first liquid A and second liquid B.

A liquid discharge head 10d differs from the liquid discharge head 10c in that the liquid discharge head 10d stirs the liquid in the pressure chamber 2 by generating the flow of liquid. The liquid-dispensing head 10d is the liquid discharge head with the liquid circulation system as same as the liquid discharge head 10c.

In the first example as illustrated in FIG. 17, the pressure chamber 2 is connected to a first supply channel 84 and a second supply channel 85. The first supply channel 84 supplies the first liquid A into the pressure chamber 2, and the second supply channel 85 supplies the second liquid B into the pressure chamber 2. The first liquid A and the second liquid B are, for example, liquids of different types. After the first liquid A and the second liquid B are supplied into the pressure chamber 2, the drive voltage is applied to the actuator 4. The actuator 4 drives, causing the first liquid A and the second liquid B to be stirred and mixed almost uniformly. Thereafter, the liquid discharge head 10d discharges the liquid from the nozzle 1.

In the second example as illustrated in FIG. 18, the supply channel 81 supplies the first liquid A and the second liquid B, which are different types, to the pressure chamber 2. The first liquid A and the second liquid B supplied to pressure chamber 2 are mixed by being stirred by the controlled flow 6e.

The liquid discharge head 10d is suitable for discharging a mixture of two different types of the liquid, A and B. For example, the liquid discharge head 10d is suitable for discharging adhesives that are cured by mixing two types of the liquid and causing a chemical reaction. However, the first liquid A and the second liquid B are not limited to components of the adhesive, and may be anything that exerts an effect through stirring. In addition, by increasing the number of supply channels, it is also possible to stir and mix three or more types of the liquid.

Next, the liquid discharge apparatus 540 will be described with reference to FIG. 19. The liquid discharge apparatus 540 includes at least one of liquid discharge head 10/10a/10b/10c/10d. In the following description, the liquid discharge apparatus 540 will be described as including the liquid discharge head 10.

FIG. 19 is a block diagram illustrating a hardware configuration of a control system of the liquid discharge apparatus 540 including a head unit 550.

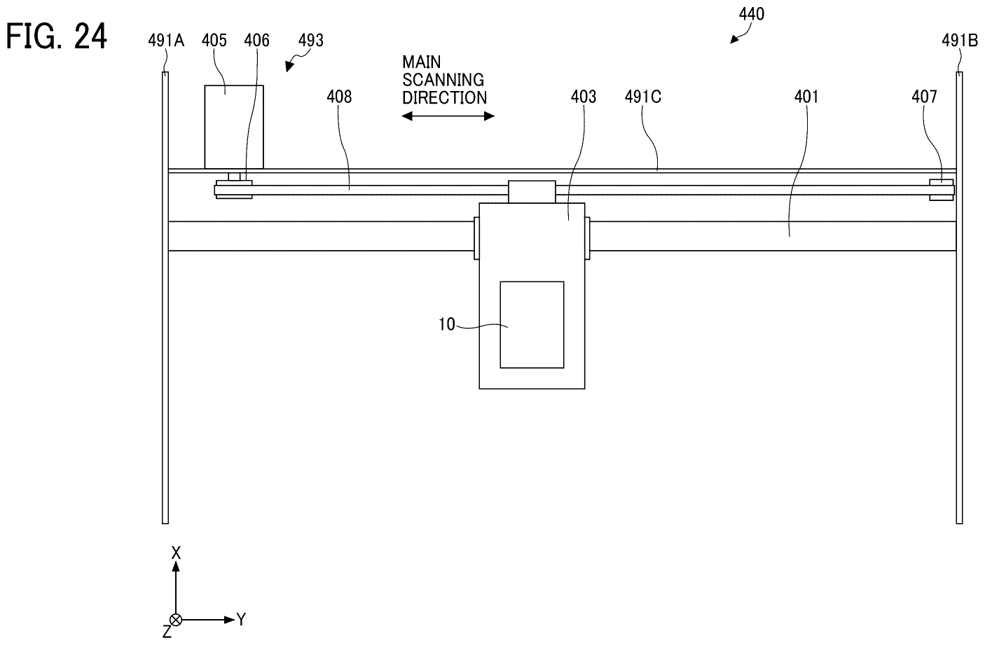

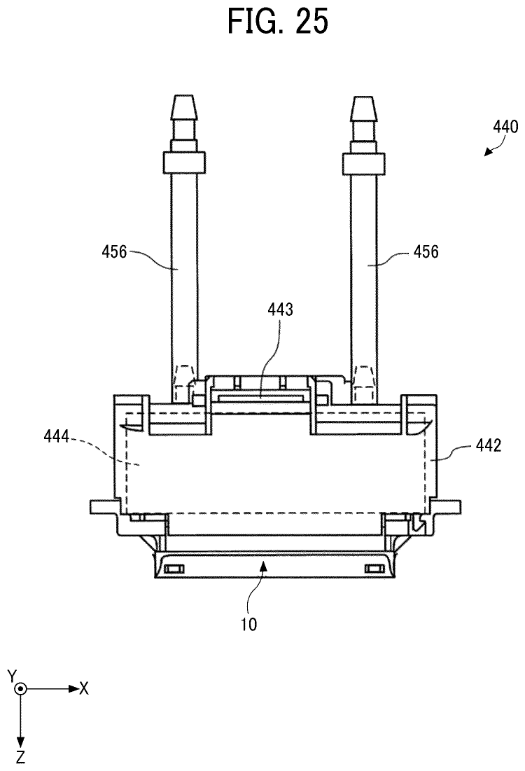

The liquid discharge apparatus 540 includes the liquid discharge head 10 and a head driver 20 that drives the liquid discharge head 10. The head driver 20 generates the controlled flow of the liquid in the pressure chamber by applying the drive voltage to the actuator of the liquid discharge head 10. The liquid discharge apparatus 540 includes a head unit 550, a controller 600, a conveyance driver 710, a control panel 720, and an input/output interface 730, which are connected to each other via a bus line 740. The head unit 550 includes the liquid discharge head 10. The liquid discharge apparatus 540 and the head unit 550 are described later with reference to FIGS. 24 and 25.

The head driver 20 generates the driving waveform that deforms each piezoelectric element, which drives as an actuator in each nozzle row and is an electromechanical transducer, in response to a control signal input from the controller 600. When the driving waveform is input to each piezoelectric element of the liquid discharge head 10 in each nozzle row, the liquid in the pressure chamber 2 communicating with the nozzle 1 is pressurized, applying discharge energy, and the liquid is discharged from the corresponding nozzle 1.

The controller 600 may include a central processing unit (CPU) 610, a storage unit 620, a random-access memory (RAM) 630, and a read-only memory (ROM) 640. The CPU 610 loads various control programs and settings stored in the ROM 640 into the RAM 630 to execute the programs to perform various arithmetic processing. The CPU 610 controls the overall operation of the liquid discharge apparatus 540.

The functionality of the elements of controller 600 disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The storage unit 620 stores, for example, a print job (image recording command) input via the input/output interface 730. Storage unit 620 may include a memory that stores a computer program which includes computer instructions for execution by CPU 610. These computer instructions may provide the logic and routines that enable the hardware (e.g., processing circuitry or circuitry) to perform the method disclosed herein. This computer program can be implemented in known formats as a computer-readable storage medium, a computer program product, a memory device, a record medium and/or the memory of a field programmable gate array (FPGA) or application-specific integrated circuit (ASIC).

The conveyance driver 710 transmits a driving signal to a conveyance motor based on a control signal supplied from the controller 600 to convey a recording medium at a predetermined speed and timing.

The control panel 720 includes a display device such as a liquid-crystal display or an organic electroluminescent display, and an input device such as a touch panel overlaid on the screen of the display device. The control panel 720 displays various kinds of information on the display device, and transmits an operation signal corresponding to a user's input operation on the input device to the controller 600.

The input/output interface 730 mediates the transmission and reception of data between an external device 800 and the controller 600.

The bus line 740 is a path through which signals are transmitted and received between the controller 600 and other components.

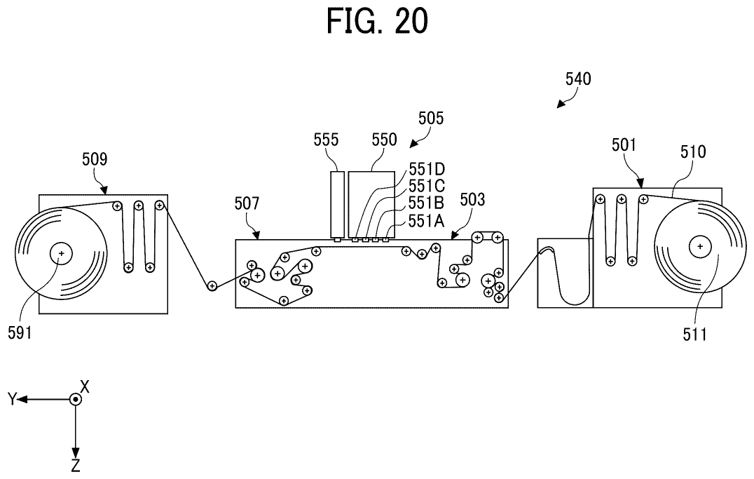

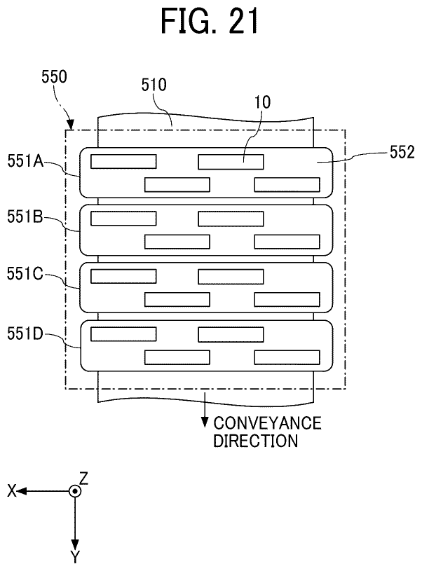

The liquid discharge apparatus 540 will be further described with reference to FIGS. 20 and 21. FIG. 20 is a schematic side view illustrating a first example of an overall configuration of the liquid discharge apparatus 540. FIG. 21 is a schematic bottom view illustrating a head unit 550 in a liquid discharge apparatus 540.

The liquid discharge apparatus 540 of FIG. 20 includes a feeder 501, a guide conveyor 503, a printer 505, a dryer 507, and a carrier 509. The feeder 501 feeds a continuous medium 510 inward. The guide conveyor 503 guides and conveys the continuous medium 510 such as a continuous sheet of paper or a sheet medium fed inward from the feeder 501. The printer 505 performs printing by discharging liquid onto the continuous medium 510 to form an image. The dryer 507 dries the continuous medium 510 with the image formed. The carrier 509 feeds the dried continuous medium 510 outward.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509.

In the printer 505, the continuous medium 510 is conveyed on a conveyance guide so as to face the head unit 550 and a head unit 555. An image is formed with liquid discharged from the head unit 550, and post-treatment is performed with treatment liquid discharged from the head unit 555.

The head unit 550 includes, for example, full-line head arrays 551A, 551B, 551C, and 551D for four colors from the upstream side in a conveyance direction of the continuous medium 510. The full-line head arrays 551A, 551B, 551C, and 551D may be referred to simply as the “head array 551” when colors are not distinguished.

Each of the head arrays 551 is a liquid discharger to discharge liquid of black (K), cyan (C), magenta (M), or yellow (Y) onto the continuous medium 510 conveyed in the conveyance direction. The number and types of colors are not limited to the above-described four colors of K, C, M, and Y and may be any other suitable number and types.

In each head array 551, for example, as illustrated in FIG. 21, the liquid discharge heads 10 are disposed in a staggered arrangement on a base 552 to form the head array 551. The configuration of the head array 551 is not limited thereto. The liquid discharge head 10 may be referred to simply as the “head 10.”

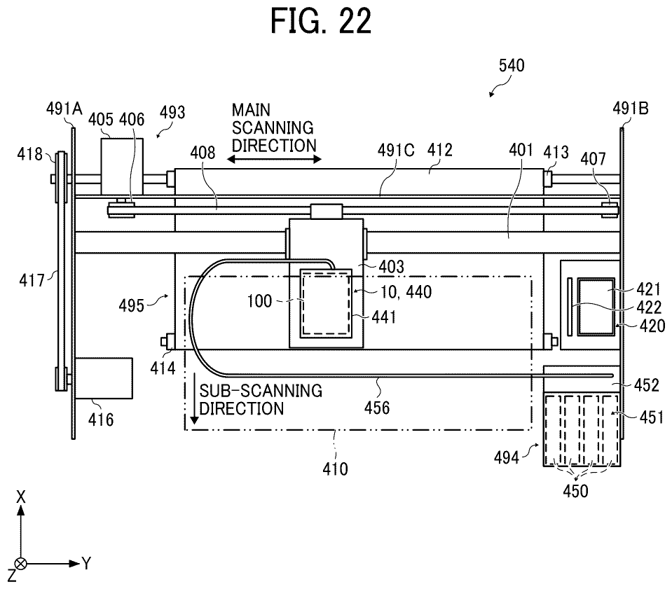

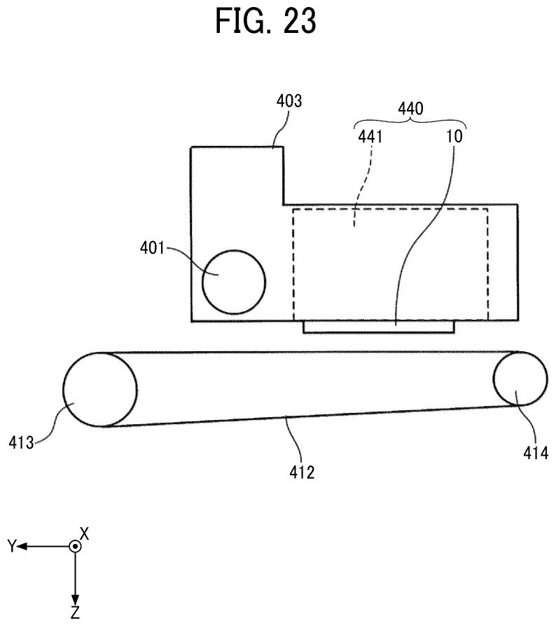

The liquid discharge apparatus 540 according to second example will be described with reference to FIGS. 22 and 23. FIG. 22 is a schematic side view illustrating a second example of an overall configuration of liquid discharge apparatus 540. FIG. 23 is a schematic diagram illustrating a configuration around a liquid discharge unit 440 in the liquid discharge apparatus 540 for the second example.

The second example of liquid discharge apparatus 540 as illustrated in FIGS. 22 and 23 is a serial-type apparatus in which a main-scanning moving mechanism 493 reciprocates a carriage 403 in the main scanning direction. The main-scanning moving mechanism 493 includes, for example, a guide 401, a main-scanning motor 405, and a timing belt 408. The guide 401 is bridged between left and right side plates 491A and 491B to movably hold the carriage 403. The main-scanning motor 405 reciprocates the carriage 403 in the main scanning direction via the timing belt 408 looped around a drive pulley 406 and a driven pulley 407.

The carriage 403 mounts a liquid discharge unit 440 including the liquid discharge head 10 and a head tank 441 as a single integrated unit. The liquid discharge head 10 of the liquid discharge unit 440 discharges color liquids of, for example, yellow (Y), cyan (C), magenta (M), and black (K). The liquid discharge head 10 is mounted on the liquid discharge unit 440 of the carriage 403 such that a nozzle row including multiple nozzles is arranged in the sub-scanning direction perpendicular to the main scanning direction. The liquid discharge head 10 discharges the color liquid downward.

A supply mechanism 494 disposed outside the liquid discharge head 10 supplies liquid stored in liquid cartridges 450 to the head tank 441 to supply the liquid to the liquid discharge head 10.

The supply mechanism 494 includes a cartridge holder 451 which is a filling part to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The liquid discharge apparatus 540 further includes a conveyance mechanism 495 to convey a sheet 410. The conveyance mechanism 495 includes a conveyance belt 412 as a conveyor and a sub-scanning motor 416 to drive the conveyance belt 412.

The conveyance belt 412 attracts the sheet 410 and conveys the sheet 410 to a position facing the liquid discharge head 10. The conveyance belt 412 is an endless belt looped around a conveyance roller 413 and a tension roller 414. The sheet 410 can be attracted to the conveyance belt 412 by, for example, electrostatic attraction or air suction.

The conveyance belt 412 circumferentially moves in a sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head 10 is disposed lateral to the conveyance belt 412.

The maintenance mechanism 420 includes, for example, a cap 421 to cap the nozzle face (i.e., the surface on which the nozzles 4 are formed) of the liquid discharge head 10 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C.

In the liquid discharge apparatus 540having the above-described configuration, the sheet 410 is fed and attracted onto the conveyance belt 412 and conveyed in the sub-scanning direction as the conveyance belt 412 circumferentially moves.

The liquid discharge head 10 is driven in response to an image signal while the carriage 403 moves in the main scanning direction to discharge liquid onto the sheet 410 not in motion. As a result, an image is formed on the sheet 410.

As described above, the liquid discharge apparatus 540according to the first of second examples includes the liquid discharge head 10, thus allowing the stable formation of high-quality images.

Another liquid discharge unit 440 will be described with reference to FIG. 24. FIG. 24 is a schematic top view illustrating a first example of a liquid discharge unit 440.

The liquid discharge unit 440 as illustrated in FIG. 24 includes a housing, the main-scanning moving mechanism 493, the carriage 403, and the liquid discharge head 10 among the components of the liquid discharge apparatus 540 described above. The side plates 491A and 491B, and the back plate 491C may constitute the housing.

The liquid discharge unit 440 may further include at least one of the maintenance mechanism 420 and the supply mechanism 494, which may be attached to the side plate 491B.

A second example of the liquid discharge unit 440 will be described with reference to FIG. 25. FIG. 25 is a schematic side view illustrating a second example of a liquid discharge unit 440. The liquid discharge unit 440 includes the liquid discharge head 10 to which a channel component 444 is attached and tubes 456 connected to the channel component 444.

The channel component 444 is disposed inside a cover 442. Alternatively, the liquid discharge unit 440 may include the head tank 441 instead of the channel component 444. A connector 443 for electrically connecting to the liquid discharge head 10 is provided on an upper portion of the channel component 444.

In the above-described embodiments, the liquid discharge apparatus includes the liquid discharge head or the liquid discharge unit and drives the liquid discharge head to discharge the liquid. The liquid discharge apparatus may be, for example, any apparatus that can discharge liquid to a medium onto which liquid can adhere or any apparatus to discharge liquid toward gas or into liquid.

The liquid discharge apparatus may further include devices relating to feeding, conveying, and ejecting of the medium onto which liquid can adhere and also include a pretreatment device and an aftertreatment device.

The liquid discharge apparatus may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The liquid discharge apparatus is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, deoxyribonucleic acid (DNA) sample, resist, pattern material, binder, fabrication liquid, and solution or liquid dispersion containing amino acid, protein, or calcium. Further, the “liquid” may be a molten metal such as solder.

The liquid discharge apparatus may be an apparatus to move the liquid discharge head and the material onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The integrated unit may be, for example, a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional part(s) or unit(s) each other.

Examples of the liquid discharge unit include the liquid discharge unit 440 in which a liquid discharge head and a head tank are integrated, as illustrated in FIG. 23. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. Like the liquid discharge unit 440 illustrated in FIG. 24, the liquid discharge head, the carriage, and the main-scanning moving mechanism may form the liquid discharge unit as a single unit.

In another example, the cap that forms a part of the maintenance mechanism is secured to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head to which the head tank or the channel component is attached so that the liquid discharge head and the supply mechanism are integrated as a single unit, as illustrated in FIG. 25.

The main-scanning moving mechanism may be a guide only. The supply mechanism may be a tube(s) only or a loading device only.

The liquid discharge head is not limited in the type of pressure generator used. The pressure generator is not limited to the piezoelectric actuator (or a laminated-type piezoelectric element) described in the above-described embodiments, and may be, for example, a thermal actuator that employs a thermoelectric transducer element, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

Note that numerous additional modifications and variations are possible in light of the above teachings. It is therefore to be understood that within the scope of the appended claims, the embodiments of the present disclosure may be practiced otherwise than as specifically described herein. For example, elements and/or features of different illustrative embodiments may be combined with each other and/or substituted for each other within the scope of this disclosure and appended claims.

Aspects of the present disclosure are, for example, as follows.

### Aspect 1

A liquid discharge head includes a pressure chamber, a nozzle to discharge a liquid from the pressure chamber, a nozzle plate on the pressure chamber, and an actuator on the nozzle plate, the actuator deforming the nozzle plate to discharge the liquid in the pressure chamber from the nozzle, wherein a drive voltage is applied to the actuator to generate a controlled flow of the liquid in the pressure chamber.

### Aspect 2

In the liquid discharge head according to Aspect 1, the nozzle plate includes an inner surface facing the pressure chamber, and the controlled flow includes a flow of the liquid along the inner surface.

### Aspect 3

In the liquid discharge head according to Aspect 2, the controlled flow includes a flow of the liquid in a direction away from the nozzle.

### Aspect 4

In the liquid discharge head according to Aspect 2 or 3, the controlled flow includes a flow located closer to the inner surface than a facing surface opposite the inner surface in the pressure chamber.

### Aspect 5

In the liquid discharge head according to any one of Aspect 1 to 4, at least one of a waveform, voltage value, and frequency of the drive voltage applied to the actuator is adjusted to control the controlled flow.

### Aspect 6

In the liquid discharge head according to any one of Aspect 1 to 5, a first drive voltage is applied to the actuator to discharge the liquid from the nozzle, and a second drive voltage, which is the drive voltage, is applied to the actuator to generate the controlled flow in the pressure chamber which does not discharge the liquid from the nozzle, the second drive voltage being smaller than the first drive voltage.

### Aspect 7

In the liquid discharge head according to any one of Aspect 1 to 6, the actuator is a piezoelectric element

### Aspect 8

In the liquid discharge head according to any one of Aspect 1 to 7, the controlled flow is generated to periodically switch between a first flow of the liquid in a direction away from the nozzle and a second flow of the liquid in a direction closer to the nozzle.

### Aspect 9

In the liquid discharge head according to any one of Aspect 1 to 8, the nozzle plate vibrates when the drive voltage is applied to the actuator.

### Aspect 10

In the liquid discharge head according to any one of Aspect 1 to 9, a portion of the liquid in the pressure chamber is discharged from the pressure chamber by pressurization or suction, and the flow moves an air bubble from a first position to a second position, the first position being where the air bubble cannot be discharged by pressurization or suction within the pressure chamber, and the second position being where the bubble can be discharged by pressurization or suction.

### Aspect 11

In the liquid discharge head according to any one of Aspect 1 to 10, a plurality of the pressure chambers including the pressure chamber, a plurality of supply channels through which the liquid is supplied to the plurality of the pressure chambers; and a plurality of discharge channels through which the liquid is discharged from the plurality of the pressure chambers, wherein a portion of the liquid circulates within the pressure chamber, and the controlled flow moves an air bubble from a first position to a second position, the first position being where the air bubble cannot be discharged by circulation of the liquid within the pressure chamber, and the second position being where the bubble can be discharged by circulation of the liquid.

### Aspect 12

In the liquid discharge head according to any one of Aspect 1 to 11, the controlled flow stirs the liquid within the pressure chamber.

### Aspect 13

A liquid discharge apparatus includes a head driver to drive the liquid discharge head according to any one of Aspect 1 to 12, wherein the head driver generates the controlled flow of the liquid in the pressure chamber by applying the drive voltage to the actuator.

### Aspect 14

A liquid discharge apparatus includes a liquid discharge head including a pressure chamber, a nozzle to discharge a liquid from the pressure chamber, a nozzle plate on the pressure chamber, and an actuator on the nozzle plate, the actuator deforming the nozzle plate to discharge the liquid in the pressure chamber from the nozzle, and a head driver configured to apply a drive voltage to the actuator to generate a controlled flow of the liquid in the pressure chamber.

### Aspect 15

In the liquid discharge apparatus according to Aspect 14, the nozzle plate includes an inner surface facing the pressure chamber, and the controlled flow includes a flow of the liquid along the inner surface.

### Aspect 16

In the liquid discharge apparatus according to Aspect 14 or 15, the controlled flow includes a flow of the liquid in a direction away from the nozzle.

### Aspect 17

In the liquid discharge apparatus according to any one of Aspect 14 to 16, the head driver adjusts at least one of a waveform, voltage value, and frequency of the drive voltage applied to the actuator to control the controlled flow.

### Aspect 18

In the liquid discharge apparatus according to any one of Aspect 14 to 17, the head driver applies a first drive voltage to the actuator to discharge the liquid from the nozzle, and the head driver applies a second drive voltage, which is the drive voltage, to the actuator to generate the controlled flow in the pressure chamber which does not discharge the liquid from the nozzle, the second drive voltage being smaller than the first drive voltage.

### Aspect 19

In the liquid discharge head according to Aspect 1 or 2, the controlled flow includes a flow located closer to the inner surface than a facing surface opposite the inner surface in the pressure chamber.

### Aspect 20

A liquid discharge method for controlling a liquid discharge head including a pressure chamber, a nozzle, a nozzle plate on the pressure chamber, and an actuator on the nozzle plate, the liquid discharge method comprising applying a first drive voltage to the actuator to deform the nozzle plate to discharge a liquid from the pressure chamber via the nozzle; and applying a second drive voltage the actuator to generate a controlled flow of the liquid in the pressure chamber without discharging the liquid from the nozzle, wherein the second drive voltage is smaller than the first drive voltage.

1. A liquid discharge head, comprising:
a pressure chamber;
a nozzle to discharge a liquid from the pressure chamber;
a nozzle plate on the pressure chamber; and
an actuator on the nozzle plate, the actuator deforming the nozzle plate to discharge the liquid in the pressure chamber from the nozzle, wherein
a drive voltage is applied to the actuator to generate a controlled flow of the liquid in the pressure chamber.

2. The liquid discharge head according to claim 1, wherein:
the nozzle plate includes an inner surface facing the pressure chamber, and
the controlled flow includes a flow of the liquid along the inner surface.

3. The liquid discharge head according to claim 2, wherein:
the controlled flow includes a flow of the liquid in a direction away from the nozzle.

4. The liquid discharge head according to claim 2, wherein:
the controlled flow includes a flow located closer to the inner surface than a facing surface opposite the inner surface in the pressure chamber.

5. The liquid discharge head according to claim 1, wherein:
at least one of a waveform, voltage value, and frequency of the drive voltage applied to the actuator is adjusted to control the controlled flow.

6. The liquid discharge head according to claim 1, wherein:
a first drive voltage is applied to the actuator to discharge the liquid from the nozzle, and
a second drive voltage, which is the drive voltage, is applied to the actuator to generate the controlled flow in the pressure chamber which does not discharge the liquid from the nozzle, the second drive voltage being smaller than the first drive voltage.

7. The liquid discharge head according to claim 1, wherein:
the actuator is a piezoelectric element.

8. The liquid discharge head according to claim 1, wherein:
the controlled flow is generated to periodically switch between a first flow of the liquid in a direction away from the nozzle and a second flow of the liquid in a direction closer to the nozzle.

9. The liquid discharge head according to claim 1, wherein:
the nozzle plate vibrates when the drive voltage is applied to the actuator.

10. The liquid discharge head according to claim 1, wherein:
a portion of the liquid in the pressure chamber is discharged from the pressure chamber by pressurization or suction, and
the flow moves an air bubble from a first position to a second position, the first position being where the air bubble cannot be discharged by pressurization or suction within the pressure chamber, and the second position being where the bubble can be discharged by pressurization or suction.

11. The liquid discharge head according to claim 1, further comprising:
a plurality of the pressure chambers including the pressure chamber;
a plurality of supply channels through which the liquid is supplied to the plurality of the pressure chambers; and
a plurality of discharge channels through which the liquid is discharged from the plurality of the pressure chambers, wherein
a portion of the liquid circulates within the pressure chamber, and
the controlled flow moves an air bubble from a first position to a second position, the first position being where the air bubble cannot be discharged by circulation of the liquid within the pressure chamber, and the second position being where the bubble can be discharged by circulation of the liquid.

12. The liquid discharge head according to claim 1, wherein:
the controlled flow stirs the liquid within the pressure chamber.

13. A liquid discharge apparatus, comprising:
a head driver to drive the liquid discharge head according to claim 1, wherein
the head driver generates the controlled flow of the liquid in the pressure chamber by applying the drive voltage to the actuator.

14. A liquid discharge apparatus, comprising:
a liquid discharge head including:
a pressure chamber;
a nozzle to discharge a liquid from the pressure chamber;
a nozzle plate on the pressure chamber; and
an actuator on the nozzle plate, the actuator deforming the nozzle plate to discharge the liquid in the pressure chamber from the nozzle; and
a head driver configured to apply a drive voltage to the actuator to generate a controlled flow of the liquid in the pressure chamber.

15. The liquid discharge apparatus according to claim 14, wherein:
the nozzle plate includes an inner surface facing the pressure chamber, and
the controlled flow includes a flow of the liquid along the inner surface.

16. The liquid discharge apparatus according to claim 15, wherein:
the controlled flow includes a flow of the liquid in a direction away from the nozzle.

17. The liquid discharge head according to claim 2, wherein:
the controlled flow includes a flow located closer to the inner surface than a facing surface opposite the inner surface in the pressure chamber.

18. The liquid discharge apparatus according to claim 14, wherein:
The head driver adjusts at least one of a waveform, voltage value, and frequency of the drive voltage applied to the actuator to control the controlled flow.

19. The liquid discharge apparatus according to claim 14, wherein:
the head driver applies a first drive voltage to the actuator to discharge the liquid from the nozzle, and
the head driver applies a second drive voltage, which is the drive voltage, to the actuator to generate the controlled flow in the pressure chamber which does not discharge the liquid from the nozzle, the second drive voltage being smaller than the first drive voltage.

20. A liquid discharge method for controlling a liquid discharge head including a pressure chamber, a nozzle, a nozzle plate on the pressure chamber, and an actuator on the nozzle plate, the liquid discharge method comprising:
applying a first drive voltage to the actuator to deform the nozzle plate to discharge a liquid from the pressure chamber via the nozzle; and
applying a second drive voltage the actuator to generate a controlled flow of the liquid in the pressure chamber without discharging the liquid from the nozzle, wherein
the second drive voltage is smaller than the first drive voltage.
